(19) United States
(12) Patent Application Publication
(10) Pub. No.: US 2011/0153645 A1
(43) Pub. Date: Jun. 23, 2011

(54) SYSTEM AND METHOD FOR FACILITATING A SELECTIVE LOCATION-BASED INTERACTIVE CAMPAIGN IN A WIRELESS ENVIRONMENT

(75) Inventors: Roger Hoover, San Bruno, CA (US); Dorrian Porter, Menlo Park, CA (US); Huajun Qin, Fremont, CA (US); Irvin Remedios, San Francisco, CA (US)

(73) Assignee: MOZES INCORPORATED, Palo Alto, CA (US)

(21) Appl. No.: 12/646,588

(22) Filed: Dec. 23, 2009

(51) Int. Cl. G06F 17/30

(52) U.S. Cl. 707/769; 707/802; 707/758; 707/E17.014; 707/E17.044

(57) ABSTRACT

Methods, apparatuses, and computer program products are disclosed that facilitate providing and managing location-based interactive campaigns. With respect to facilitating providing location-based interactive campaigns, a geographic location is defined within a virtual fence, and associated with an interactive campaign. Location data identifying a current location of a wireless device is then received and processed to determine whether to include or exclude the wireless device from participating in the interactive campaign based on the current location relative to the defined geographic location. With respect to facilitating the management of location-based interactive campaigns, a configurable campaign profile is stored and configured according to a first configuration. The configurable campaign profile is then reconfigured according to a second configuration in response to receiving an input associated with the configurable campaign profile.

### TECHNICAL FIELD

The subject disclosure generally relates to wireless interactive campaigns, and more particularly to a centralized system and method for facilitating location-based interactive campaigns.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

With the rapidly increasing popularity and capabilities of wireless devices, people are becoming much more dependent on wireless devices as a means of receiving information than ever before. In response to this phenomenon, many advertisers and retailers have attempted to push advertising content onto users via campaigns directed towards their respective wireless devices (e.g., via SMS). However, conventional systems for providing such campaigns have several drawbacks.

For instance, most conventional systems are “on-site” systems, which may only push content onto users within broadcast range of the on-site system. Therefore, if a user of such on-site system wishes to implement a second broadcast campaign at a different location, the user would have to either set up a second on-site system or transfer the existing on-site system to the second location. Neither of these options is desirable, however, since they both result in a loss of time and money.

Conventional broadcast campaigns are also undesirable since they provide no mechanism for targeting particular users. Indeed, most conventional systems simply push content onto any user within its broadcast range. As a result, many users may lack interest in the content, and advertisers and retailers may be reluctant to invest in improving the content of such campaigns.

Accordingly, it would be desirable to provide a mechanism for seamlessly providing selective location-based interactive campaigns in disparate locations. The above-described deficiencies of today's broadcast campaigns are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In various non-limiting embodiments, aspects for facilitating providing and managing location-based interactive campaigns are described. In a first embodiment, a method that facilitates providing a location-based interactive campaign is described. Within such embodiment, a processor is employed to execute computer executable instructions stored on a computer readable storage medium to implement a series of acts. The series of acts includes, defining at least one geographic location in which the at least one geographic location includes an area within a virtual fence. The series of acts also includes associating an interactive campaign with the at least one geographic location, as well as receiving location data associated with a wireless device in which the location data identifies a current location of the wireless device. Another act of this particular embodiment includes ascertaining whether to include or exclude the wireless device from participating in the interactive campaign based on the current location of the wireless device relative to the at least one geographic location.

In another embodiment, an apparatus that facilitates providing a location-based interactive campaign is described, which includes a processor configured to execute computer executable components stored in memory. Within such embodiment, the computer executable components include a virtual fence component, a campaign database component, a receiving component, and a determination component. The virtual fence component is configured to define at least one geographic location in which the at least one geographic location includes an area within a virtual fence, whereas the campaign database component is configured to store data corresponding to each of a plurality of interactive campaigns, wherein each of the interactive campaigns is associated with at least one corresponding geographic location. With respect to the receiving component, the receiving component is configured to receive location data identifying a current location of a wireless device. For this particular embodiment, the determination component is then configured to make a determination of whether to include or exclude the wireless device from participating in an interactive campaign, wherein the determination is at least partly based on the current location of the wireless device relative to a corresponding geographic location.

In yet another embodiment, a method that facilitates managing a location-based interactive campaign is described, which includes employing a processor to execute computer executable instructions stored on a computer readable storage medium. Within such embodiment, the processor is employed to implement a series of steps including storing a configurable campaign profile that facilitates exchanging data associated with a campaign exclusively to a set of users having wireless devices located within a geographic area defined by the configurable campaign profile. In another step, the configurable campaign profile is configured according to a first configuration that facilitates exchanging the data associated with the campaign exclusively to a first set of users having wireless devices located within a first geographic area defined by the first configuration. The configurable campaign profile is then reconfigured according to a second configuration in response to receiving an input associated with the configurable campaign profile. For this particular embodiment, the second configuration facilitates exchanging the data associated with the campaign exclusively to a second set of users having wireless devices located within a second geographic area defined by the second configuration, wherein the first geographic area and the second geographic area are mutually exclusive.

These and other embodiments are described in more detail below.

### BRIEF DESCRIPTION OF THE DRAWINGS

Various non-limiting embodiments are further described with reference to the accompanying drawings in which:

FIG. 1 illustrates an exemplary system that facilitates providing a location-based interactive campaign in accordance with some aspects;

FIG. 2 illustrates a block diagram of an exemplary campaign manager unit that facilitates providing a location-based interactive campaign in accordance with an aspect of the subject specification;

FIG. 3 is an illustration of an exemplary coupling of electrical components that facilitates providing a location-based interactive campaign;

FIG. 4 is a diagram illustrating an exemplary scenario in which a location-based interactive campaign may be implemented in accordance with an embodiment;

FIG. 5 is a flow chart illustrating an exemplary methodology that facilitates providing a location-based interactive campaign for the scenario illustrated in FIG. 4;

FIG. 6 is a diagram illustrating another exemplary scenario in which a location-based interactive campaign may be implemented in accordance with an embodiment;

FIG. 7 is a flow chart illustrating an exemplary methodology that facilitates providing a location-based interactive campaign for the scenario illustrated in FIG. 6;

FIG. 8 is a diagram illustrating an exemplary scenario in which management of a location-based interactive campaign may be implemented in accordance with an embodiment;

FIG. 9 is a flow chart illustrating an exemplary methodology for facilitating management of a location-based interactive campaign in accordance with an embodiment;

FIG. 10 is an illustration of an exemplary coupling of electrical components that facilitate managing a location-based interactive campaign;

FIG. 11 is a block diagram representing exemplary non-limiting networked environments in which various embodiments described herein can be implemented; and

FIG. 12 is a block diagram representing an exemplary non-limiting computing system or operating environment in which one or more aspects of various embodiments described herein can be implemented.

### DETAILED DESCRIPTION

The subject specification discloses various embodiments directed towards facilitating location-based interactive campaigns. As used herein, the term “interactive campaign” refers to a communication campaign either solicited by a wireless device or pushed onto a wireless device. Accordingly, an interactive campaign may include a communication campaign initiated by a wireless device, a centralized system, and/or a third party.

As discussed in the background, conventional systems only provide broadcast campaigns via “on-site” systems, which do not provide broadcast capabilities beyond the sites in which they reside. The subject specification overcomes this limitation by providing a centralized system configured to support various interactive campaigns directed towards multiple disparate geographic locations. Furthermore, whereas conventional systems simply push content onto any user within broadcast range, the subject specification discloses an interactive system that can selectively provide content to users according to any of a plurality of parameters.

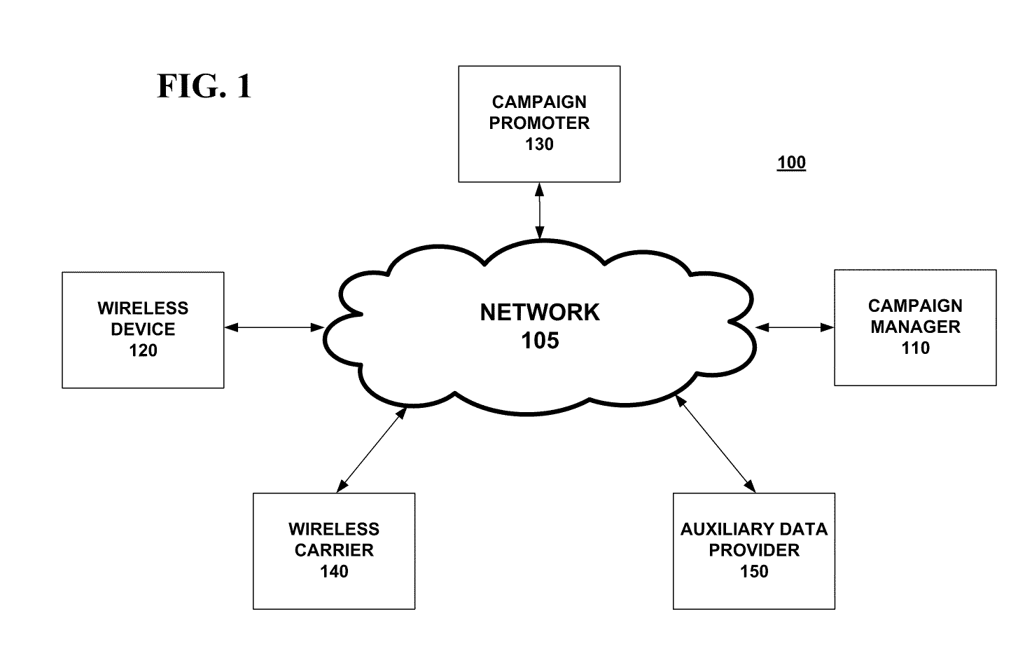

Referring next to FIG. 1, an exemplary system that facilitates providing a location-based interactive campaign in accordance with some aspects is provided. As illustrated, system 100 includes a campaign manager unit 110 configured to provide and manage location-based interactive campaigns for campaign promoters 130 via network 105. In an exemplary embodiment, campaign manager 110 utilizes location data pertaining to wireless devices 120 (e.g., GPS data) to determine whether any of wireless devices 120 are within a geographic location associated with a particular interactive campaign. Namely, by associating each of a plurality of campaigns with a corresponding geographic location, campaign manager 110 may define each geographic location as an area within a virtual fence, wherein eligibility to participate in a campaign depends on whether individual wireless devices 120 are within a corresponding virtual fence. For instance, with respect to participating in a particular interactive campaign, campaign manager 110 may actively include wireless devices 120 located within the campaign's virtual fence, whereas wireless devices 120 outside the campaign's virtual fence are actively excluded from participation.

As illustrated, system 100 may further include wireless carriers 140. Here, since location data is not always available from wireless devices 120 directly, campaign manager 110 may instead obtain such location data from wireless carriers 140.

For some aspects, in addition to location data, it may be desirable to validate a user's eligibility to participate in a particular campaign with non-location data (hereinafter “auxiliary data”). For instance, such auxiliary data may include a password/keyword entered by a user. However, such auxiliary data may also include third party data provided by auxiliary data providers 150 (e.g., information confirming a user's employment, political party affiliation, age, etc.).

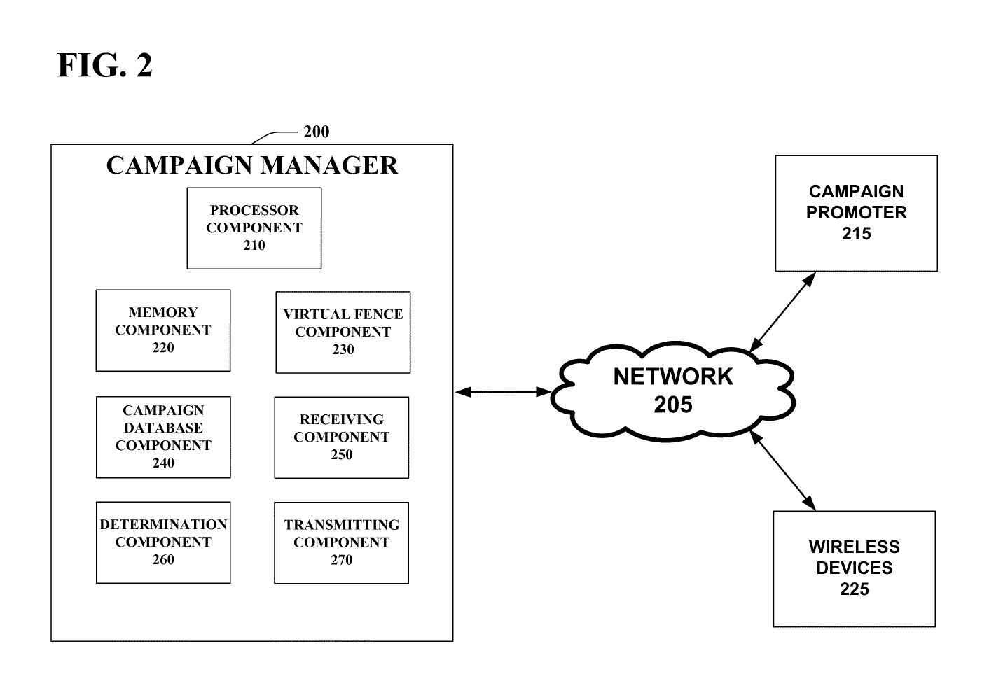

Referring next to FIG. 2, a block diagram of an exemplary campaign manager unit that facilitates providing a location-based interactive campaign is provided. In an aspect, campaign promoters 215 configure campaign manager 200 to provide their respective campaigns to wireless devices 225 in a customized manner. For instance, campaign promoters 215 may launch a user interface on a local device to facilitate configuring a particular campaign profile remotely stored on campaign manager unit 200. Campaign manager unit 200 may then provide campaigns to wireless devices 225 via network 205 based on the respective custom settings provided by campaign promoters 215.

As shown, campaign manager 200 may include processor component 210, memory component 220, virtual fence component 230, campaign database component 240, receiving component 250, determination component 260, and transmitting component 270. In one aspect, processor component 210 is configured to execute computer-readable instructions related to performing any of a plurality of functions. Processor component 210 can be a single processor or a plurality of processors dedicated to analyzing information to be communicated from wireless terminal 200 and/or generating information that can be utilized by memory component 220, virtual fence component 230, campaign database component 240, receiving component 250, determination component 260, and/or transmitting component 270. Additionally or alternatively, processor component 210 may be configured to control one or more components of campaign manager 200.

In another aspect, memory component 220 is coupled to processor component 210 and configured to store computer-readable instructions executed by processor component 210. Memory component 220 may also be configured to store any of a plurality of other types of data including data received via receiving component 250, as well as data generated by any of virtual fence component 230, campaign database component 240, receiving component 250, determination component 260, and/or transmitting component 270. Memory component 220 can be configured in a number of different configurations, including as random access memory, battery-backed memory, hard disk, magnetic tape, etc. Various features can also be implemented upon memory component 220, such as compression and automatic back up (e.g., use of a Redundant Array of Independent Drives configuration).

In yet another aspect, virtual fence component 230 is configured to define a geographic location as an area within a virtual fence. For instance, in an exemplary embodiment, virtual fence component 230 may define a geographic location as a circular area centered at a particular street address and having an x-mile radius. Within such embodiment, the virtual fence would thus be the perimeter of the circular area, wherein the geographic location is defined to include the entire area within the virtual fence. In other embodiments, however, non-circular virtual fences are also contemplated. For instance, in an exemplary embodiment, campaign promoters 215 might draw a virtual fence manually on a touch screen displaying a map (e.g., by using a stylus). In another embodiment, campaign promoters 215 might simply enter various coordinates (e.g., street intersections, addresses, etc.), wherein such coordinates are connected to create the virtual fence.

As illustrated, campaign manager 200 may also include campaign database component 240. Within such embodiment, campaign database component 240 may be configured to store data corresponding to each of a plurality of interactive campaigns. For instance, campaign database component 240 may be configured as a relational database, wherein each of the plurality of interactive campaigns is associated with at least one corresponding geographic location. Moreover, within such embodiment, each interactive campaign is associated with at least one corresponding virtual fence, wherein only wireless devices 225 within the virtual fence(s) corresponding to a particular interactive campaign are eligible to receive a correspondence associated with such campaign. Here, in addition to data relating interactive campaigns to corresponding geographic locations, campaign database component 240 may also store correspondence data for each interactive campaign, wherein such correspondence data may include an actual correspondence corresponding to a particular interactive campaign and/or data identifying such correspondence (e.g., a pointer/link to an external location where such correspondence resides).

In another aspect, campaign manager 200 also includes receiving component 250, which is configured to receive data from external entities. For instance, receiving component 250 may be configured to receive location data identifying the current location of wireless devices 225 (e.g., GPS data received either directly from wireless devices 225 and/or from a wireless carrier). Receiving component 250 may also be configured to receive auxiliary data for validating whether wireless devices 225 are eligible to receive a correspondence for a particular interactive campaign (e.g., an answer to a trivia question received from a wireless device, confirmation of employment with a particular company received from a wireless device user's company, etc.), as well as basic commands/inputs from wireless devices 225 (e.g., a password to a personalized account, requests to participate in a particular interactive campaign, queries for interactive campaigns encompassing the wireless device's current location, etc.).

In order to ascertain the eligibility of wireless devices 225 to participate in a particular campaign, campaign manager 200 may further include determination component 260. In an exemplary embodiment, determination component 260 is configured to determine whether to include or exclude the wireless device from participating in an interactive campaign based on whether the current location of the wireless device is within a geographic location corresponding to the particular interactive campaign. Determination component 260 may be further configured to generate a list of all interactive campaigns encompassing the wireless device's current location and/or a subset of such interactive campaigns. For instance, determination component 260 may be further configured to determine a wireless device's eligibility to participate in an interactive campaign based on any of a plurality of factors. For instance, some interactive campaigns may require a particular input from a wireless device (e.g., an explicit request for participation, a password/keyword, etc.) and/or a particular validation from a third party (e.g., confirmation from a voter database that the wireless device is associated with a registered voter, confirmation from an employer that the wireless device is associated with an employee, etc.).

In another aspect, campaign manager 200 includes transmitting component 270, which may be configured to transmit data to external entities. For instance, if determination component 260 determines that a wireless device is eligible to participate in a particular interactive campaign, transmitting component 270 may be configured to transmit an electronic correspondence associated with the interactive campaign to the wireless device and/or an alternate destination associated with the wireless device (e.g., an e-mail address, a social networking site, etc., wherein the destination may be selected by the user of the wireless device and/or determined by the terms of the particular campaign). Here, although the aforementioned electronic correspondence may include text, files, and/or objects comprising actual data desired by a wireless device user, it should be noted that the electronic correspondence might not include such data. For instance, transmission component 270 may simply send a hyperlink to such data. In another embodiment, transmission component 270 may notify a third party that campaign manager 200 has validated the wireless device's presence in a particular geographic location, wherein the third party may then use such information as it desires (e.g., for research purposes, to send the user of the wireless device electronic/tangible correspondence regarding the third party, etc.).

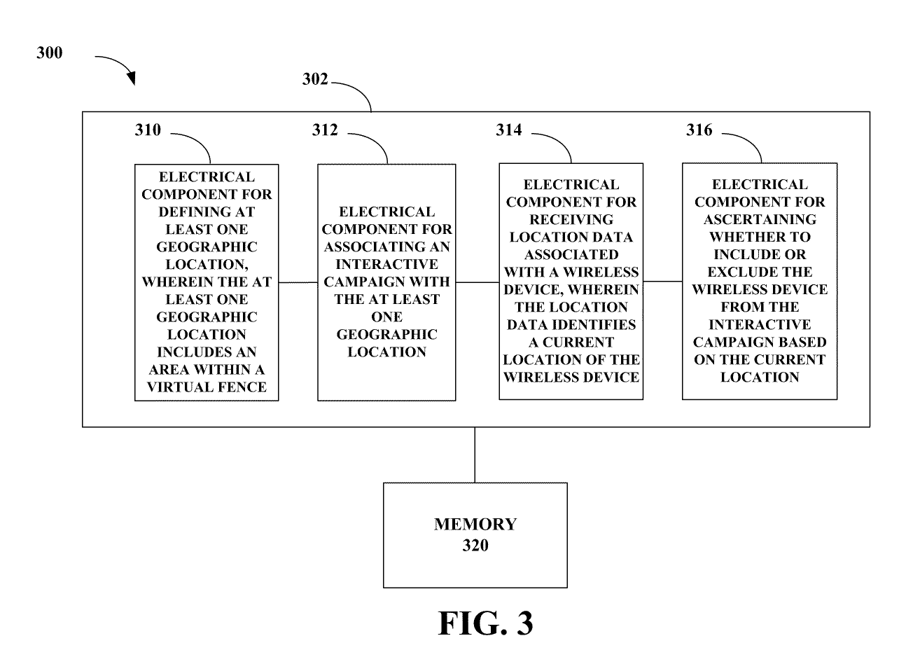

Turning to FIG. 3, illustrated is a system 300 that facilitates providing a location-based interactive campaign in a wireless communication environment. System 300 can reside within a computing device, such as campaign manager 110 or campaign manager 200, for instance. As depicted, system 300 includes functional blocks that can represent functions implemented by a processor, software, or combination thereof (e.g., firmware). System 300 includes a logical grouping 302 of electrical components that can act in conjunction. As illustrated, logical grouping 302 can include an electrical component for defining at least one geographic location, wherein the at least one geographic location includes an area within a virtual fence 310. Logical grouping 302 can also include an electrical component for associating an interactive campaign with the at least one geographic location 312, as well as an electrical component for receiving location data associated with a wireless device, wherein the location data identifies a current location of the wireless device 314. Furthermore, logical grouping 302 can include an electrical component for ascertaining whether to include or exclude the wireless device from the interactive campaign based on the current location of the wireless device relative to the at least one geographic location 316. Additionally, system 300 can include a memory 320 that retains instructions for executing functions associated with electrical components 310, 312, 314, 316, and 318. While shown as being external to memory 320, it is to be understood that electrical components 310, 312, 314, 316, and 318 can exist within memory 320.

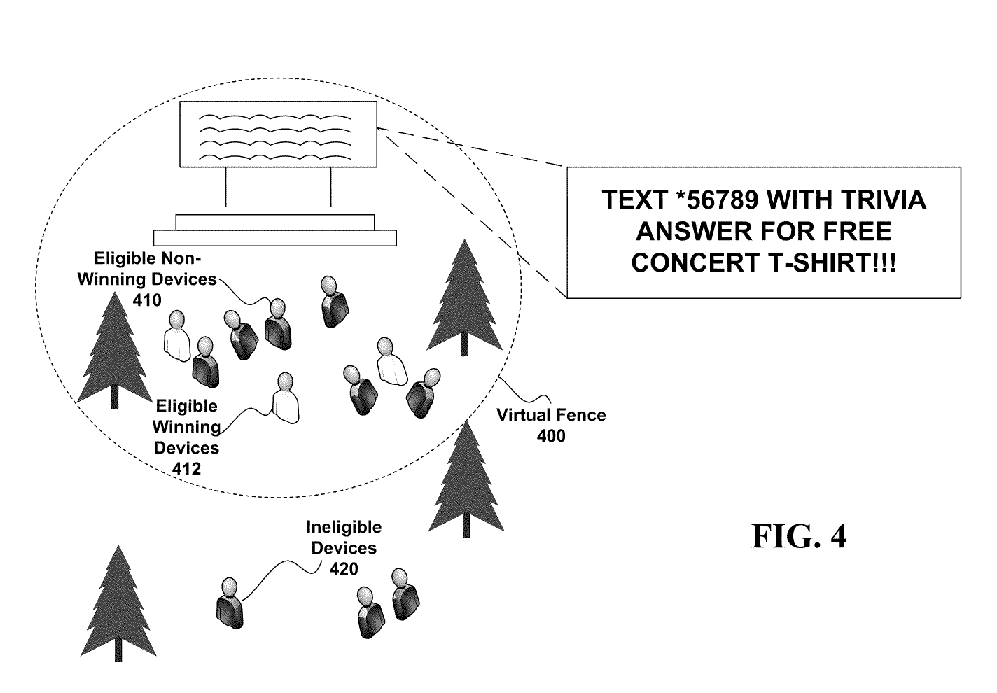

Referring next to FIG. 4, a diagram illustrating an exemplary scenario in which a location-based interactive campaign may be implemented is provided. For this particular scenario, a campaign promoter would like to provide attendees of a concert an opportunity to win a free concert T-shirt by answering a trivia question via SMS. To implement such a campaign, a virtual fence 400 is associated with the campaign and designed to substantially encompass the concert grounds, as shown. Accordingly, only attendees having devices 410, 412 within virtual fence 400 are eligible to participate in this particular interactive campaign. Attendees within virtual fence 400 who correctly answer the trivia question via their wireless device 412 will therefore win a T-shirt, whereas attendees who provide an incorrect answer via their wireless device 410 (or provide no answer at all) will not win a T-shirt. Here, since non-attendees may unscrupulously attempt to participate via their devices 420, the present invention provides a mechanism for identifying such non-attendees as being outside virtual fence 400 and thus excluding them from participating in this particular campaign.

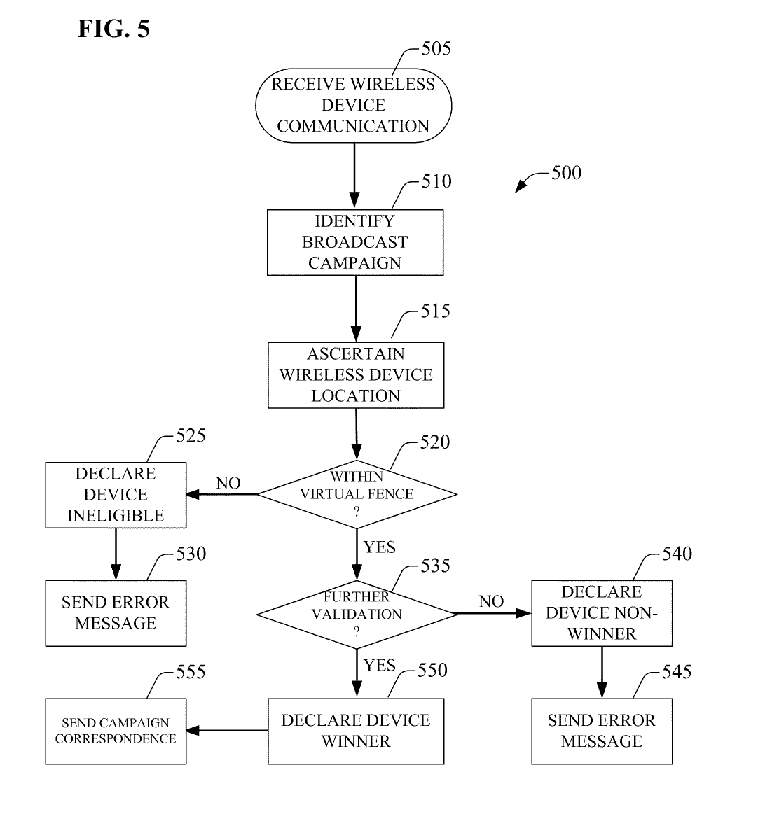

Referring next to FIG. 5, a flow chart illustrating an exemplary methodology that facilitates providing a location-based interactive campaign for the aforementioned concert scenario is provided. As illustrated, process 500 includes a series of acts that may be performed by a computing device such as campaign manager unit 200. For instance, process 500 may be implemented by employing a processor to execute computer executable instructions stored on a computer readable storage medium to implement the series of acts. In another embodiment, a computer-readable storage medium comprising code for implementing the steps of process 500 is contemplated.

In an aspect, process 500 begins by receiving a communication from wireless devices 410, 412, and 420 at step 505. Next, at step 510, the particular campaign targeted by the communication is identified (e.g., via the number texted, a keyword entered by the user, etc.).

Process 500 then proceeds to step 515 where the respective locations of wireless device 410, 412, and 420 are ascertained, followed by a determination at step 520 of whether such locations are within virtual fence 400. Here, it should be noted that the respective locations of wireless devices 410, 412, and 420 are ascertainable in any of a plurality of ways. For instance, GPS data provided directly from wireless devices 410, 412, and 420 could have been included in the communication received at step 505. Alternatively, such GPS data may be obtainable from the respective wireless carriers of wireless device 410, 412, and 420.

In another aspect, determining whether wireless devices 410, 412, and 420 are within virtual fence 400 is ascertainable via an on-site mechanism. For instance, such on-site mechanism may confirm whether a user is within virtual fence 400 by determining whether either of wireless devices 410, 412, or 420 utilized an on-site network (e.g., a personal area network (PAN), local area network (LAN), etc.). Similarly, since a phone number associated with either of wireless devices 410, 412, or 420 may be the same number associated with a credit card used to purchase tickets to the concert, a simple scan of the ticket at a turnstile may be utilized to confirm whether either of wireless devices 410, 412, or 420 is within virtual fence 400.

For wireless device 420, a determination is made at step 520 that wireless device 420 is outside virtual fence 400. Therefore, with respect to wireless device 420, process 500 continues to step 525 where wireless device 420 is declared ineligible and thus excluded from participating in the interactive campaign. An error message is then sent to wireless device 420 at step 530 indicating that it is ineligible to participate in this particular campaign. Alternatively, in order to preserve bandwidth, process 500 may simply exclude all ineligible wireless devices without sending an error message step 530.

For wireless devices 410 and 412, each of wireless devices 410 and 412 are confirmed to be within virtual fence 400, at step 520. Therefore, with respect to each of wireless devices 410 and 412, process 500 proceeds to step 535 for further validation. For this particular example, such validation includes determining whether wireless devices 410 and 412 have provided a correct trivia answer.

For wireless device 410, a determination is made at step 535 that wireless device 410 provided an incorrect trivia answer. Therefore, with respect to wireless device 410, process 500 continues by declaring wireless device 410 a non-winner at step 540. An error message is then sent to wireless device 410 at step 545 indicating that an incorrect answer was provided.

For wireless device 412, a determination is made at step 535 that wireless device 412 provided a correct trivia answer. Therefore, with respect to wireless device 412, process 500 continues by declaring wireless device 412 a winner at step 550. At step 555, process 500 may then conclude with the transmission of a correspondence related to this particular campaign (e.g., an e-mail that includes an electronic coupon for the concert T-shirt, a tangible correspondence in which the actual T-shirt is mailed to the user, etc.).

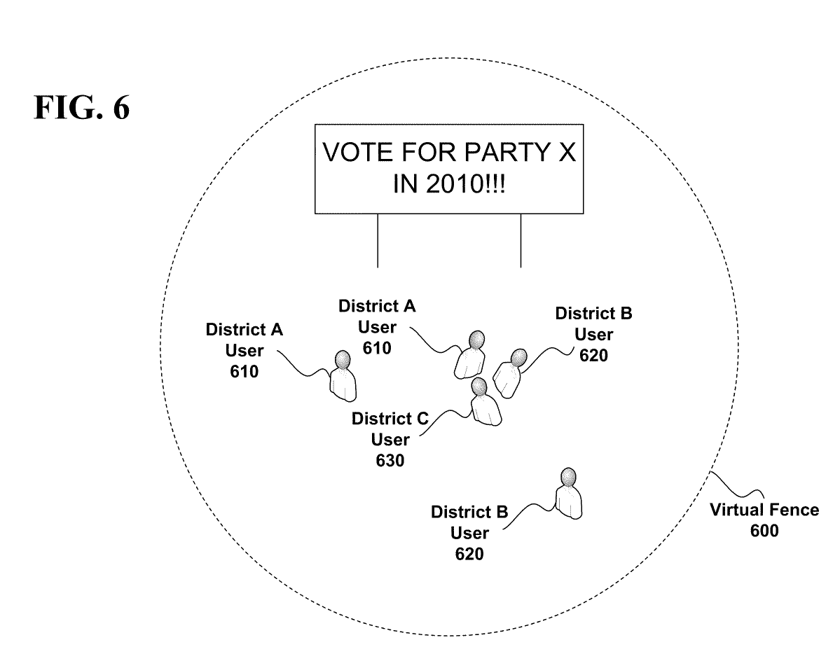

In some instances, rather than requiring an input from a user, it is sometimes desirable to “push” campaign correspondence onto the user. Referring next to FIG. 6, a diagram illustrating an exemplary scenario for pushing correspondence related to a location-based interactive campaign is provided. For this particular scenario, a campaign promoter would like to provide district-specific literature to attendees of a convention for a political party. To implement such a campaign, a virtual fence 600 is associated with the campaign and designed to substantially encompass the convention center in which this convention is held, as shown. Accordingly, only attendees having devices 610, 620, and 630 within virtual fence 600 are eligible to receive literature associated with this particular interactive campaign. For this campaign, unlike the campaign described with respect to FIG. 4, the campaign promoter desires to “push” literature onto attendees independent of a user input. To reduce the intrusiveness of push campaigns, users may first be required to “opt-in” to receiving correspondence related to such campaigns.

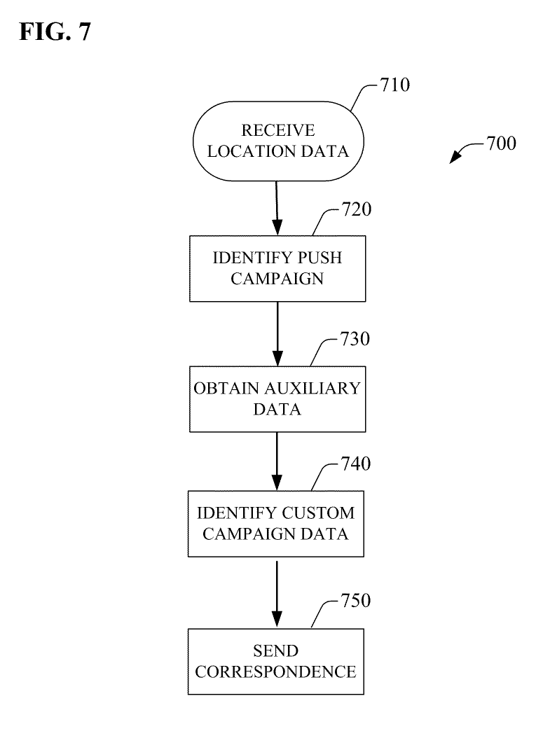

Referring next to FIG. 7, a flow chart illustrating an exemplary methodology that facilitates providing a location-based interactive campaign for the aforementioned political convention scenario is provided. Similar to process 500, process 700 includes a series of acts that may be performed by a computing device such as campaign manager unit 200. For instance, process 700 is again implementable by employing a processor to execute computer executable instructions stored on a computer readable storage medium to implement the series of acts. In another embodiment, a computer-readable storage medium comprising code for implementing the steps of process 700 is contemplated.

In an aspect, process 700 begins by receiving location data pertaining to wireless devices 610, 620, and 630 at step 710. Next, at step 720, since the received location data indicates that each of wireless devices 610, 620, and 630 are within virtual fence 600, campaign manager 200 identifies the push campaign corresponding to virtual fence 600.

Process 700 then continues by obtaining auxiliary data related to each of wireless devices 610, 620, and 630 at step 730. For this particular scenario, since the campaign promoter would like to provide district-specific information, the auxiliary data obtained at step 730 may include any of various types of data obtained from any of a plurality of sources. For instance, residential addresses respectively corresponding to the users of wireless devices 610, 620, and 630, may be obtained from an internal location (e.g., a user profile stored within campaign manager 200) and/or an external location (e.g., a voter registration database accessed by campaign manager 200).

After obtaining auxiliary data at step 730, process 700 may then proceed by identifying the appropriate district-specific campaign data for each user, at step 740. Here again, it should be noted that such campaign data may include any of various types of data stored in any of a plurality of sources. For instance, campaign data may be stored in an internal location (e.g., campaign database component 240) and/or an external location (e.g., a database maintained by the political party hosting the convention).

Next, upon identifying the district-specific campaign data for each user, process 700 continues by facilitating the transmission of a related correspondence at step 750. Specifically, campaign manager 200 facilitates sending district-specific literature related to each of districts “A”, “B”, and “C” to the users of wireless devices 610, 620, and 630, respectively. It should be noted that such literature may include tangible literature (e.g., sent by a third party publisher) and/or electronic literature (e.g., sent by campaign manager 200 as a hyperlink/attachment via e-mail, SMS, MMS, or the like).

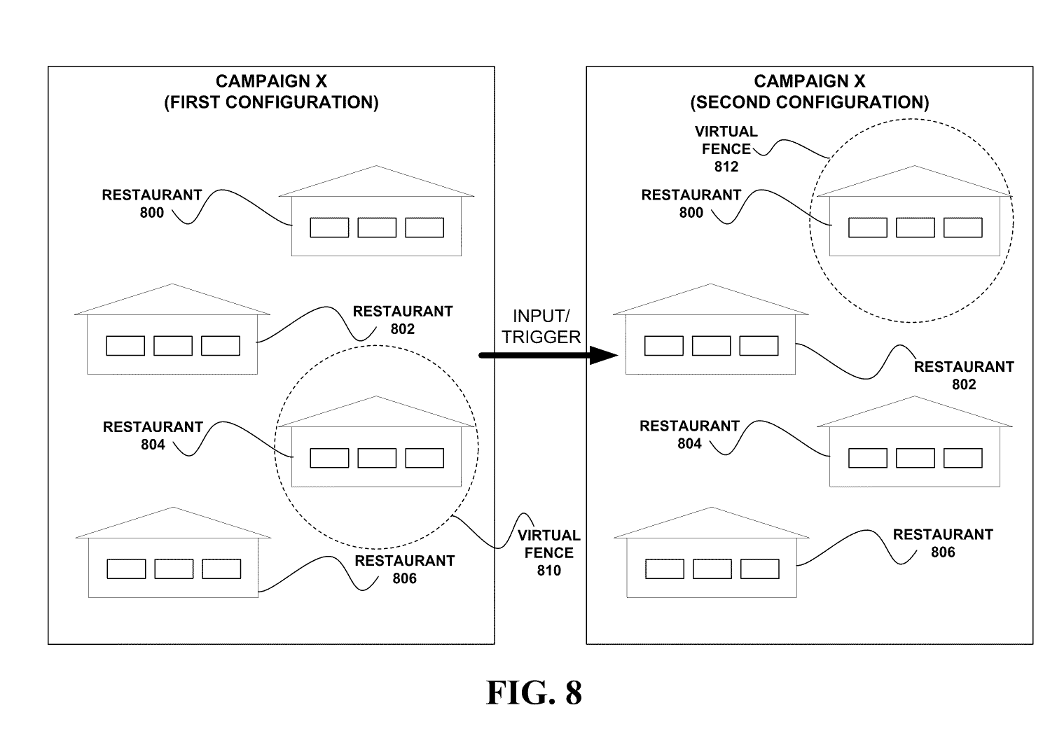

In another embodiment, the subject specification discloses novel aspects for facilitating the management of a location-based interactive campaign. Referring next to FIG. 8, illustrated is a diagram of an exemplary scenario in which management of a location-based interactive campaign in accordance with an embodiment is implementable. For this particular scenario, a campaign promoter manages an interactive campaign (“Campaign X”) directed towards a restaurant chain having a plurality of restaurants 800, 802, 804, and 806. As illustrated, Campaign X may include different configurations, wherein a different virtual fence 810, 812 is associated with each configuration. For this particular embodiment, Campaign X may thus operate as a finite state machine such that the virtual fence(s) active in a first state may be different than the virtual fence(s) active in a second state. Furthermore, each configuration/state may require a unique trigger/input to transition to another configuration/state.

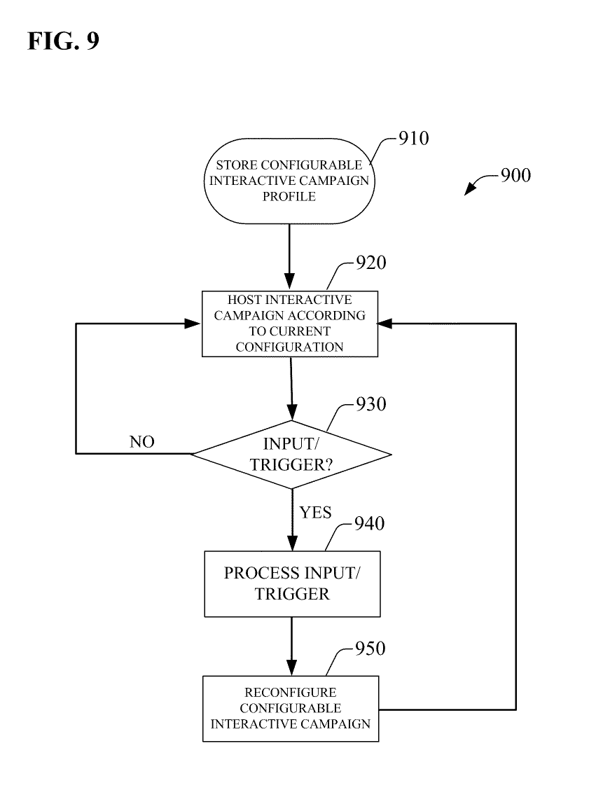

Referring next to FIG. 9, a flow chart illustrating an exemplary methodology that facilitates managing a location-based interactive campaign for the aforementioned restaurant chain scenario is provided. Similar to processes 500 and 700, process 900 includes a series of acts that may be performed by a computing device such as campaign manager unit 200. Here, process 900 is again implementable by employing a processor to execute computer executable instructions stored on a computer readable storage medium to implement the series of acts. A computer-readable storage medium comprising code for implementing the steps of process 900 is also contemplated.

In an aspect, process 900 begins by storing the configurable interactive campaign profile corresponding to the restaurant chain campaign at step 910. Next, at step 920, the restaurant chain campaign is hosted according to the current configuration of the campaign manager 200. For instance, as illustrated in FIG. 8, the restaurant chain campaign may begin in a first configuration, and subsequently transition into a second configuration in response to a particular trigger/input.

At step 930, process 900 thus continues by monitoring the occurrence of a particular trigger/input. Here, it should be noted that each configuration may utilize any of a plurality of types of triggers/inputs. For instance, in an aspect, the restaurant chain campaign switches configurations in response to an input provided by the campaign promoter (e.g., an input in which the restaurant chain campaign transitions from having virtual fence 810 encompass restaurant 804 to having virtual fence 812 encompass restaurant 800).

For other aspects, however, transitioning between configurations is controllable via automation. For instance, the occurrence of a particular trigger event may automatically cause the restaurant chain campaign to transition from having virtual fence 810 encompass restaurant 804 to having virtual fence 812 encompass restaurant 800. Exemplary trigger events for this particular campaign may include time-sensitive trigger events (e.g., having a virtual fence surround only restaurants 800, 802, 804, and/or 806 where the local time is before noon, wherein the campaign pushes/receives breakfast coupons onto/from wireless devices during that time), sales-sensitive trigger events (e.g., having a virtual fence surround the restaurant 800, 802, 804, or 806 having the highest quarterly sales, wherein the campaign “pushes” gift certificates to employees of the highest selling restaurant), weather-sensitive trigger events (e.g., having a virtual fence surround only restaurants 800, 802, 804, and/or 806 where the local temperature exceeds one hundred degrees, wherein the campaign pushes/receives ice scream coupons onto/from wireless devices during that time), as well as various other types of trigger events.

Referring back to process 900, if a trigger/input is not detected at step 930, process 900 loops back to step 920 where the restaurant chain campaign continues to host the restaurant chain campaign according to the first configuration. However, if a trigger/input is indeed detected, process 900 proceeds by processing the trigger/input at step 940, and subsequently reconfiguring the campaign at step 950 according to the particular trigger/input detected. Once the campaign is reconfigured at step 950, process 900 loops back to step 920 where the campaign is hosted according to the reconfigured campaign.

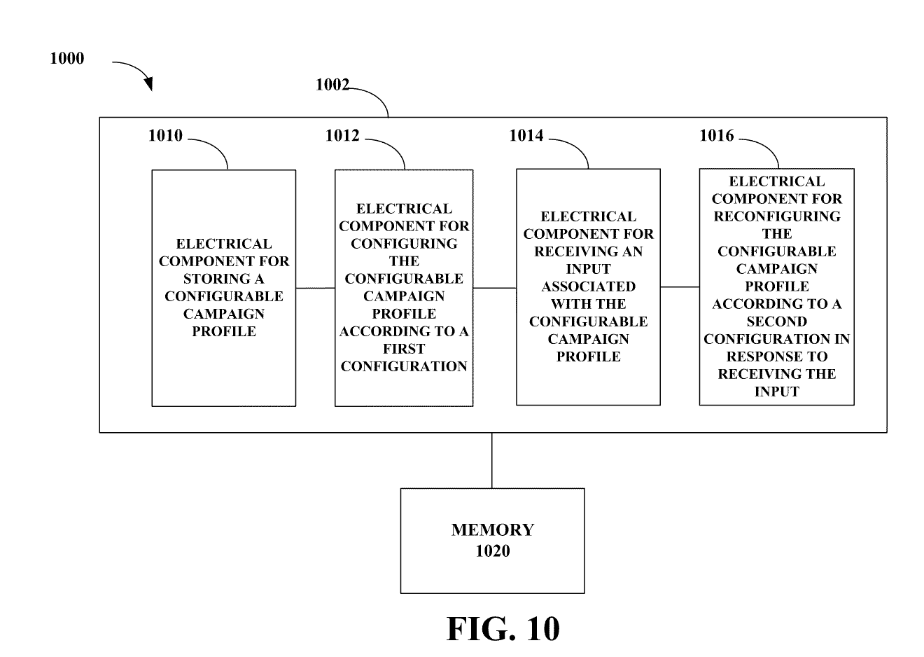

Referring next to FIG. 10, illustrated is a system 1000 that facilitates managing a location-based interactive campaign in a wireless communication environment. System 1000 can reside within a computing device, such as campaign manager 110 or campaign manager 200 for instance, wherein system 1000 includes functional blocks that can represent functions implemented by a processor, software, or combination thereof (e.g., firmware). Moreover, system 1000 includes a logical grouping 1002 of electrical components that can act in conjunction similar to logical grouping 302 in system 300. As illustrated, logical grouping 1002 can include an electrical component for storing a configurable campaign profile 1010. Logical grouping 1002 can also include an electrical component for configuring the configurable campaign profile according to a first configuration 1012, as well as an electrical component for receiving an input associated with the configurable campaign profile 1014. Furthermore, logical grouping 1002 can include an electrical component for reconfiguring the configurable campaign profile according to a second configuration in response to receiving the input 1016. Additionally, system 1000 can include a memory 1020 that retains instructions for executing functions associated with electrical components 1010, 1012, 1014, and 1016. While shown as being external to memory 1020, it is to be understood that electrical components 1010, 1012, 1014, and 1016 can exist within memory 1020.

### Exemplary Networked and Distributed Environments

One of ordinary skill in the art can appreciate that the various embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may be used to implement the various embodiments of the subject disclosure.

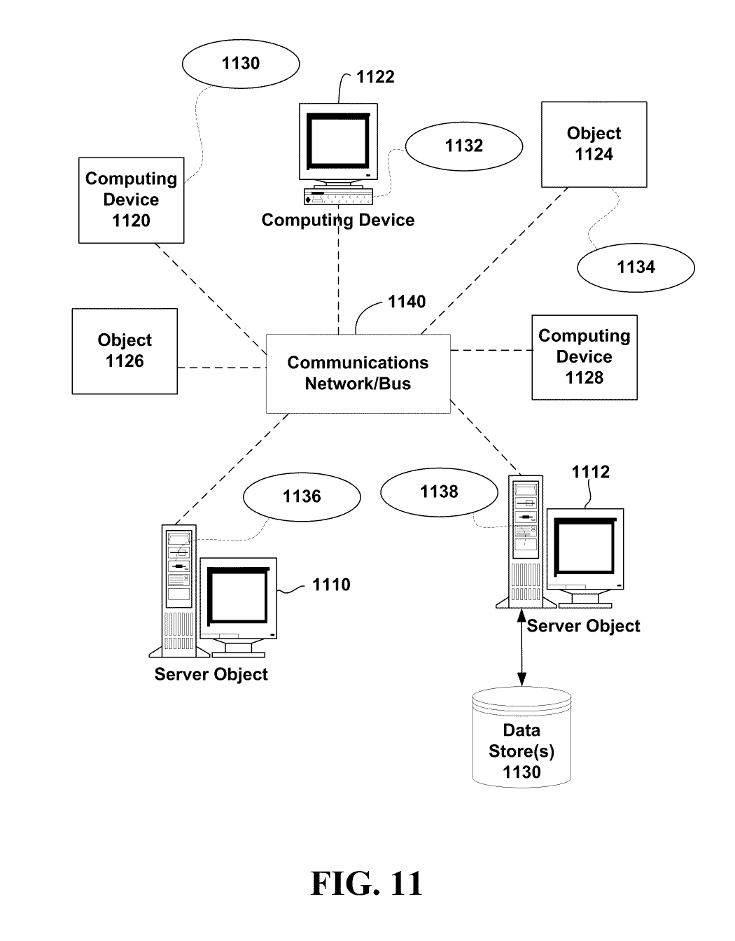

FIG. 11 provides a schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that objects 1110, 1112, etc. and computing objects or devices 1120, 1122, 1124, 1126, 1128, etc. may comprise different devices, such as PDAs, audio/video devices, mobile phones, MP3 players, personal computers, laptops, etc.

Each object 1110, 1112, etc. and computing objects or devices 1120, 1122, 1124, 1126, 1128, etc. can communicate with one or more other objects 1110, 1112, etc. and computing objects or devices 1120, 1122, 1124, 1126, 1128, etc. by way of the communications network 1140, either directly or indirectly. Even though illustrated as a single element in FIG. 11, network 1140 may comprise other computing objects and computing devices that provide services to the system of FIG. 11, and/or may represent multiple interconnected networks, which are not shown. Each object 1110, 1112, etc. or 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of the systems provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the various embodiments described herein.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 11, as a non-limiting example, computers 1120, 1122, 1124, 1126, 1128, etc. can be thought of as clients and computers 1110, 1112, etc. can be thought of as servers where servers 1110, 1112, etc. provide data services, such as receiving data from client computers 1120, 1122, 1124, 1126, 1128, etc., storing of data, processing of data, transmitting data to client computers 1120, 1122, 1124, 1126, 1128, etc., although any computer can be considered a client, a server, or both, depending on the circumstances. Any of these computing devices may be processing data to execute aspects described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for performing aspects described herein can be provided either alone, or distributed across multiple computing devices or objects.

In a network environment in which the communications network/bus 1140 is the Internet, for example, the servers 1110, 1112, etc. can be Web servers with which the clients 1120, 1122, 1124, 1126, 1128, etc. communicate via any of a number of known protocols, such as the hypertext transfer protocol (HTTP). Servers 1110, 1112, etc. may also serve as clients 1120, 1122, 1124, 1126, 1128, etc., as may be characteristic of a distributed computing environment.

### Exemplary Computing Device

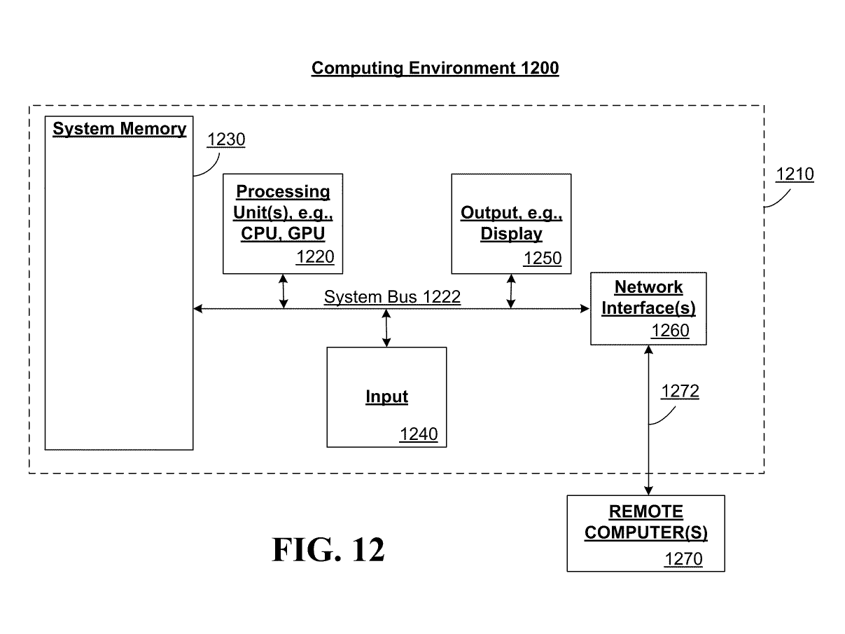

As mentioned, advantageously, the techniques described herein are implementable on any of a plurality of types of computing devices. It should be understood, therefore, that handheld, portable and other computing devices and computing objects of all kinds are contemplated for use in connection with the various embodiments. Accordingly, the below general purpose remote computer described below in FIG. 12 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 12 thus illustrates an example of a suitable computing system environment 1200 in which one or aspects of the embodiments described herein can be implemented, although as made clear above, the computing system environment 1200 is only one example of a suitable computing environment and is not intended to suggest any limitation as to scope of use or functionality. Neither should the computing environment 1200 be interpreted as having any dependency or requirement relating to any one or combination of components illustrated in the exemplary operating environment 1200.

With reference to FIG. 12, an exemplary device for implementing one or more embodiments includes a general purpose computing device in the form of a computer 1210. Components of computer 1210 may include, but are not limited to, a processing unit 1220, a system memory 1230, and a system bus 1222 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user can enter commands and information into the computer 1210 through input devices 1240. A monitor or other type of display device is also connected to the system bus 1222 via an interface, such as output interface 1250. In addition to a monitor, computers can also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1272, such local area network (LAN) or a wide area network (WAN), but may also include other networks/buses. Such networking environments are commonplace in homes, offices, enterprise-wide computer networks, intranets and the Internet.

Also, there are multiple ways to implement the same or similar functionality, e.g., an appropriate API, tool kit, driver code, operating system, control, standalone or downloadable software object, etc. which enables applications and services to use location-based campaign information as described herein. Thus, embodiments herein are contemplated from the standpoint of an API (or other software object), as well as from a software or hardware object that provides access to the location-based campaign objects. Accordingly, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method that facilitates providing a location-based interactive campaign, comprising:
employing a processor to execute computer executable instructions stored on a computer readable storage medium to implement a series of acts including:
defining at least one geographic location, wherein the at least one geographic location includes an area within a virtual fence;
associating an interactive campaign with the at least one geographic location;
receiving location data associated with a wireless device, wherein the location data identifies a current location of the wireless device; and
ascertaining whether to include or exclude the wireless device from participating in the interactive campaign based on the current location of the wireless device relative to the at least one geographic location.

2. The method of claim 1, the receiving step further comprising receiving the location data from the wireless device.

3. The method of claim 1, the receiving step further comprising receiving the location data from a third party.

4. The method of claim 1 further comprising sending a correspondence associated with the interactive campaign to a destination as a function of whether the current location of the wireless device is within the at least one geographic location.

5. The method of claim 4, wherein the destination is the wireless device.

6. The method of claim 4 further comprising receiving alternate destination data, wherein the destination is an alternate destination identified by the alternate destination data.

7. The method of claim 4, wherein the correspondence is an electronic correspondence.

8. The method of claim 4, wherein the correspondence is a tangible correspondence.

9. The method of claim 4 further comprising receiving auxiliary data, the sending act being a function of the auxiliary data.

10. The method of claim 1, the associating act further comprising associating the interactive campaign with multiple disparate geographic locations, the ascertaining act further comprising ascertaining whether the current location of the wireless device is within at least one of the multiple disparate geographic locations.

11. An apparatus that facilitates providing a location-based interactive campaign, comprising, the apparatus comprising:
a processor configured to execute computer executable components stored in memory, the components including:
a virtual fence component configured to define at least one geographic location, wherein the at least one geographic location includes an area within a virtual fence;
a campaign database component configured to store data corresponding to each of a plurality of interactive campaigns, wherein each of the plurality of interactive campaigns is associated with at least one corresponding geographic location;
a receiving component configured to receive location data associated with a wireless device, wherein the location data identifies a current location of the wireless device; and
a determination component configured to make a determination of whether to include or exclude the wireless device from participating in at least one of the plurality of interactive campaigns, wherein the determination is at least partly based on the current location of the wireless device relative to at least one of the corresponding geographic locations.

12. The apparatus of claim 11 further comprising a transmitting component, the transmitting component configured to transmit an electronic correspondence associated with at least one of the plurality of interactive campaigns to a destination.

13. The apparatus of claim 12, the determination component further configured to generate a list of potential interactive campaigns, wherein the current location of the wireless device is within at least one geographic location associated each of the potential interactive campaigns, the transmitting component further configured to transmit the list of potential interactive campaigns to the destination.

14. The apparatus of claim 11, the determination component further configured to make the determination of whether to include or exclude the wireless device independent of a request from the wireless device.

15. The apparatus of claim 11, the receiving component further configured to receive a request from the wireless device for an electronic correspondence associated with at least one of the plurality of interactive campaigns, the determination component further configured to make the determination of whether to include or exclude the wireless device as a function of the request.

16. The apparatus of claim 11, the receiving component further configured to receive auxiliary data, the determination component further configured to make the determination of whether to include or exclude the wireless device as a function of the auxiliary data.

17. The apparatus of claim 16, the receiving component further configured to receive the auxiliary data from the wireless device.

18. The apparatus of claim 16, the receiving component further configured to receive the auxiliary data from a third party.

19. A method that facilitates managing a location-based interactive campaign, comprising:
employing a processor to execute computer executable instructions stored on a computer readable storage medium to implement a series of acts including:
storing a configurable campaign profile, wherein the configurable campaign profile facilitates exchanging data associated with an interactive campaign exclusively to a set of users having wireless devices located within a geographic area defined by the configurable campaign profile;
configuring the configurable campaign profile according to a first configuration, wherein the first configuration facilitates exchanging the data associated with the interactive campaign exclusively to a first set of users having wireless devices located within a first geographic area defined by the first configuration;
receiving an input associated with the configurable campaign profile; and
reconfiguring the configurable campaign profile according to a second configuration in response to receiving the input, wherein the second configuration facilitates exchanging the data associated with the interactive campaign exclusively to a second set of users having wireless devices located within a second geographic area defined by the second configuration, and wherein the first geographic area and the second geographic area are mutually exclusive.

20. The method of claim 19, wherein the input indicates at least one of an occurrence of a trigger event or a request to reconfigure the configurable campaign profile.
